(19) United States
(12) Patent Application Publication
(10) Pub. No.: US 2020/0232499 A1
(43) Pub. Date: Jul. 23, 2020

(54) FASTENING CLIP

(71) Applicant: GM Global Technology Operations LLC, Detroit, MI (US)

(72) Inventors: Brett A. Rasmus, Troy, MI (US); Kyle E. Waid, Sterling Heights, MI (US); Jeremy P. Fellows, Davisburg, MI (US)

(21) Appl. No.: 16/251,523

(22) Filed: Jan. 18, 2019

(51) Int. Cl. F16B 37/04; F16B 37/08

(52) U.S. Cl. CPC F16B 37/043; F16B 37/0842

(57) ABSTRACT

A fastening clip for attaching a component to a panel, the component and the panel having an aperture extending through the component and the panel, the fastening clip including a clip body that is inserted into the aperture, the clip body having an internal cavity that receives a threaded fastener along an axis of the cavity; a plurality of retaining clips coupled to the clip body and projecting outwardly from the clip body, each of the retaining clips pressing against an undersurface of the panel to attach the retaining clip to the panel; a plurality of biasing tabs coupled to the clip body and projecting outwardly from the clip body, the plurality of biasing tabs biasing the clip body to a centered position within the aperture when the clip body is inserted into the aperture, the plurality of retaining clips and the plurality of biasing tabs being configure to self-center the fastening clip relative to the component and the panel when the fastening clip is inserted non-perpendicular to the component and the panel; and a seal member with an upper seal component and a lower seal component.

### INTRODUCTION

The present disclosure relates to a fastener and fastening clip for joining a component to a panel.

Many industries, such as the automotive, construction, aviation and manufacturing industries, utilize fasteners for joining or attaching one component to another. A diverse range of metal and plastic rivets, clips, and fasteners enable articles to be fastened onto panels or panels. Fastening clips, for example, are inserted into a panel surface to join a component to the panel.

While current fastening clips achieve their intended purpose, there is a need for a new and improved system and method for joining a component to a panel with a fastening clip.

### SUMMARY

According to several aspects, a fastening clip for attaching a component to a panel, the component and the panel having an aperture extending through the component and the panel, the fastening clip including a clip body that is inserted into the aperture, the clip body having an internal cavity that receives a threaded fastener along an axis of the cavity; a plurality of retaining clips coupled to the clip body and projecting outwardly from the clip body, each of the retaining clips pressing against an undersurface of the panel to attach the retaining clip to the panel; a plurality of biasing tabs coupled to the clip body and projecting outwardly from the clip body, the plurality of biasing tabs biasing the clip body to a centered position within the aperture when the clip body is inserted into the aperture, the plurality of retaining clips and the plurality of biasing tabs being configure to self-center the fastening clip relative to the component and the panel when the fastening clip is inserted non-perpendicular to the component and the panel; and a seal member with an upper seal component and a lower seal component.

In an additional aspect of the present disclosure, the fastening clip further including a plurality of ratchet fingers coupled to the clip body and extending inwardly into the internal cavity of the clip body, the plurality of ratchet fingers including at least two ratchet fingers being spaced apart and on opposite sides of the axis of the internal cavity.

In another aspect of the present disclosure, the plurality of ratchet fingers includes a third and fourth ratchet finger, the first, second, third and fourth ratchet fingers being axially spaced apart about the axis of the cavity.

In another aspect of the present disclosure, the biasing tabs are positioned diametrically opposite to each other with respect to the axis of the cavity.

In another aspect of the present disclosure, each of the plurality of fastening clips is integrally molded to the clip body.

In another aspect of the present disclosure, each of the plurality of biasing tabs is integrally molded to the clip body.

In another aspect of the present disclosure, the clip body, the plurality of retaining clips, and the plurality of biasing tabs are formed as a unitary structure.

In another aspect of the present disclosure, each of the retaining clips includes a ramp surface that engages with the aperture of the panel and component to cause the retaining clip to flex inwardly when the fastening clip is inserted the aperture of the component and panel.

According to several aspects, an assembly of a panel and a component joined together by a fastening clip includes a clip body that is inserted into an aperture that extends through the panel and the component, the clip body having an internal cavity that receives a threaded fastener along an axis of the cavity; a plurality of retaining clips coupled to the clip body and projecting outwardly from the clip body, each of the retaining clips pressing against an undersurface of the panel to attach the retaining clip to the panel; a plurality of biasing tabs coupled to the clip body and projecting outwardly from the clip body, the plurality of biasing tabs biasing the clip body to a centered position within the aperture when the clip body is inserted into the aperture, the plurality of retaining clips and the plurality of biasing tabs being configure to self-center the fastening clip relative to the component and the panel when the fastening clip is inserted non-perpendicular to the component and the panel; a plurality of ratchet fingers coupled to the clip body and extending inwardly into the internal cavity of the clip body, the plurality of ratchet fingers including at least two ratchet fingers being spaced apart and on opposite sides of the axis of the internal cavity; and a seal member with an upper seal component and a lower seal component.

In another aspect of the present disclosure, the plurality of ratchet fingers includes a third and fourth ratchet finger, the first, second, third and fourth ratchet fingers being axially spaced apart about the axis of the cavity.

In another aspect of the present disclosure, the biasing tabs are positioned diametrically opposite to each other with respect to the axis of the cavity.

In another aspect of the present disclosure, each of the plurality of fastening clips is integrally molded to the clip body.

In another aspect of the present disclosure, each of the plurality of biasing tabs is integrally molded to the clip body.

In another aspect of the present disclosure, the clip body, the plurality of retaining clips, and the plurality of biasing tabs are formed as a unitary structure.

In another aspect of the present disclosure, each of the retaining clips includes a ramp surface that engages with the aperture of the panel and component to cause the retaining clip to flex inwardly when the fastening clip is inserted the aperture of the component and panel.

According to several aspects, a method of joining a panel and a component together with a fastener and a fastening clip includes one or more of the following: inserting the fastening clip through an aperture that extends through the panel and the component, the fastening clip including a clip body that is inserted into the aperture, the clip body having an internal cavity that receives a threaded fastener along an axis of the cavity; a plurality of retaining clips coupled to the clip body and projecting outwardly from the clip body, each of the retaining clips pressing against an undersurface of the panel to attach the retaining clip to the panel; a plurality of biasing tabs coupled to the clip body and projecting outwardly from the clip body, the plurality of biasing tabs biasing the clip body to a centered position within the aperture when the clip body is inserted into the aperture, the plurality of retaining clips and the plurality of biasing tabs being configure to self-center the fastening clip relative to the component and the panel when the fastening clip is inserted non-perpendicular to the component and the panel; and a seal member with an upper seal component and a lower seal component; and passing a fastener along the axis to join the panel and the component together.

In another aspect of the present disclosure, each of the plurality of fastening clips is integrally molded to the clip body.

In another aspect of the present disclosure, each of the plurality of biasing tabs is integrally molded to the clip body.

In another aspect of the present disclosure, the clip body, the plurality of retaining clips, and the plurality of biasing tabs are formed as a unitary structure.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a perspective view of a fastener and fastening clip joining a component to a panel according to an exemplary embodiment;

FIG. 2A is a perspective view of the fastening clip;

FIG. 2B is a cross sectional view of the fastening clip;

FIG. 3A is a side view of the fastening clip;

FIG. 3B is an alternative side view of the fastening clip;

FIG. 4A is a top view of the fastening clip; and

FIG. 4B is a bottom view of the fastening clip.

### DETAILED DESCRIPTION

The following description is merely exemplary in nature and is not intended to limit the present disclosure, application, or uses.

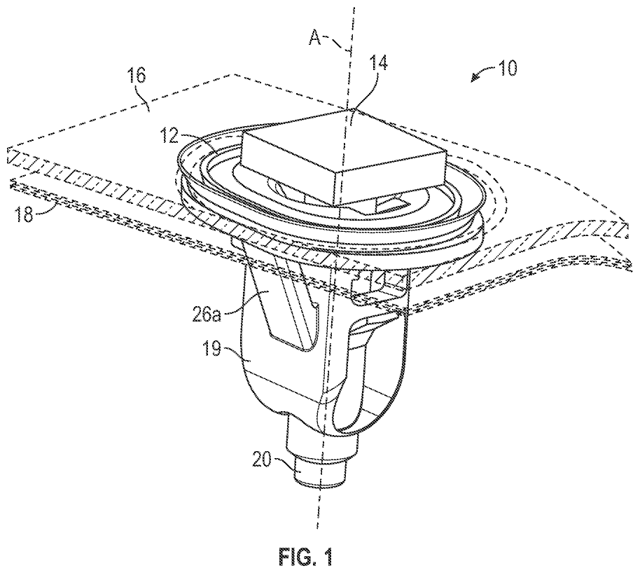

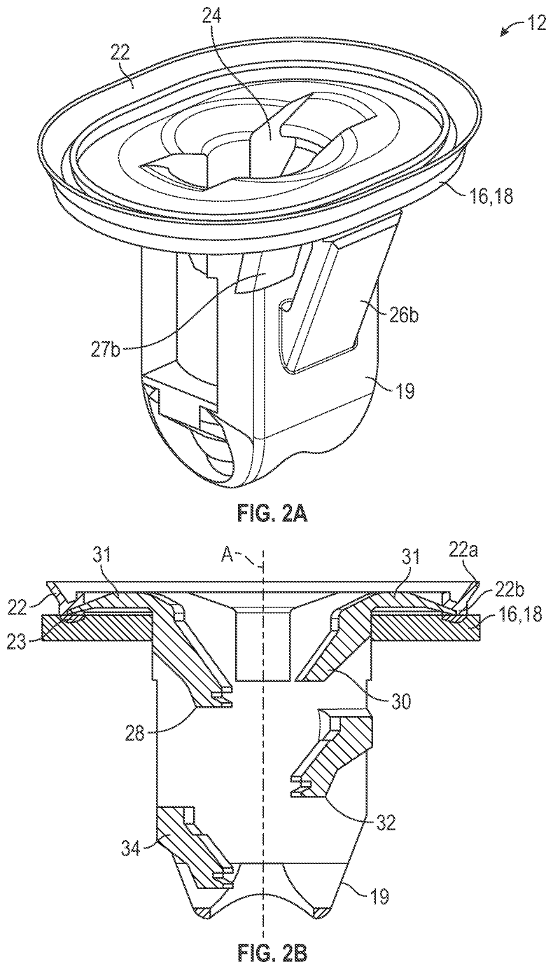

Referring now to the drawings, wherein like reference numbers refer to like features throughout the several views, there is shown in FIGS. 1, 2A and 2B an illustration of a representative mechanical fastening arrangement, designated generally at 10, for mounting a component 16 to a panel 18, for example, on a motor vehicle. It should be understood that the inventive features of the present disclosure can be integrated into other applications and utilized for other manufacturing, assembly or construction processes. Lastly, the drawings presented herein, are not necessarily to scale and are provided purely for instructional purposes. Thus, the specific and relative dimensions shown in the drawings are not to be construed as limiting.

With continuing reference to FIG. 1, the mechanical fastening arrangement 10 has two primary components: a threaded “male” fastener 14 for mating with a “female” fastening clip 12. The fastening clip 12 is designed to insert into and mount within a complementary panel aperture or hole in the component 16 and the panel 18. The illustrated segment of panel 18 is substantially flat. The threaded fastener 14 is designed to pass partially through and seat within a complementary hole of the component 16. The component 16 is then mounted to the panel 18, for example, by lowering the component 16 onto the panel 18 such that the threaded fastener 14 aligns with and inserts into the fastening clip 12, as will be described in detail below. The axis of insertion “A” (also referred to herein as “screw axis”) extends longitudinally through the center of the fastening clip 12.

The threaded fastener 14 is represented in the drawings by a bolt that includes a shank 20 with helically wrapped external threads. Located at one end of the shank 20 is a bolt head, which may be slotted, raised, hexagonal, countersunk, etc. Located at the opposing end of the shank 21 is an optional necked-down shank tip. The threaded fastener 14 can be metal or plastic, which can be coated or painted, while the threads provided thereon can be helical or non-helical and can have varying pitches, angles, diameters, etc., from those which are shown in the drawings. In accord with the illustrated example, the fastening arrangement 10 eliminates the need for a nut or dedicated tooling, such as a wrench or screwdriver, to properly install the threaded fastener 14. Although the component 16 is shown herein as being of molded plastic, the component 16 can be of metal or any suitable material and construction. Likewise, although the panel 18 is described as being a sheet metal panel, the panel 18 can be plastic, composite, etc.

The fastening clip 12 can be fabricated as a single-piece, unitary structure that is integrally formed, for example, from a molded plastic or a precision-tooled metal. While any of an assortment of geometries and dimensions are envisioned, the illustrated fastening clip 12 includes an elongated, tubular clip body 19 having a toroidal flange 31 (FIG. 2B) that extends continuously around the perimeter of a first “upper” end of the body 19. The clip body 19 is shaped and sized to insert into and nest generally co-terminously with the aperture of the component 16 and the panel 18. The flange 31 engages with a seal 22, more specifically, a bottom portion 22b of a two portions 22a and 22b of the seal 22. The bottom portion of the seal 22b engages with the topside of the component 16 to prevent the fastening clip 12 from passing in its entirety through the panel 18. The clip body 19 has a hollow internal cavity for receiving therein the threaded fastener 14. In accord with the illustrated example, the fastening arrangement 10 eliminates the need for internal “female” threads within the fastening clip 12 to mate with the threads of the threaded fastener 14. Put another way, the clip body 19 can be characterized by a lack of internal threads within the internal cavity for threadably engaging the threaded fastener 14. One or more optional lateral openings are provided in the sides of the clip body 19, for example, to facilitate a polymer injection molding process for the manufacture of the fastening clip 12.

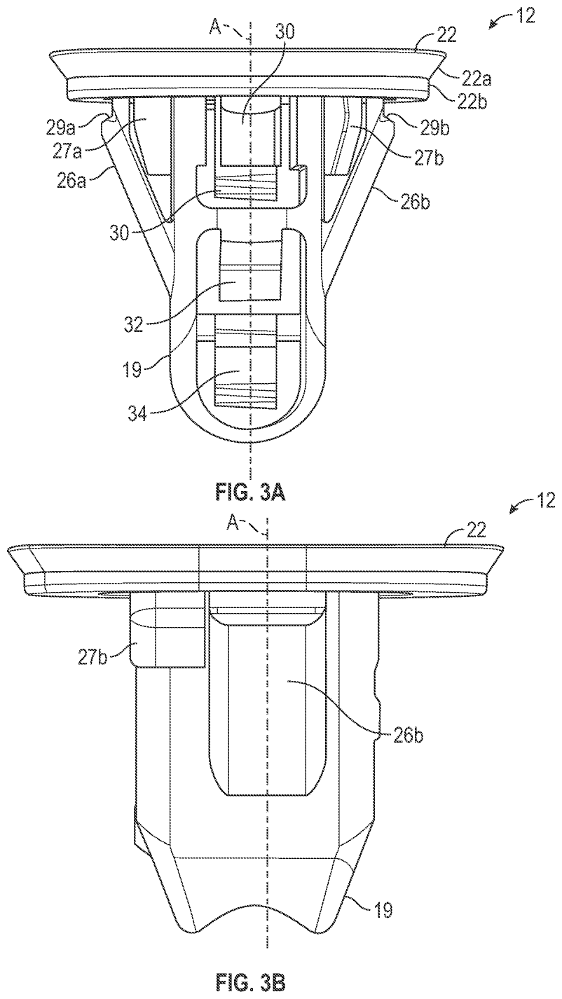

Integrally formed with or otherwise positively attached to the clip body 20 are first and second flexible retaining clips 26a and 26b, respectively, which project outwardly at an oblique angle from opposing sides of the clip body 19. The undersides of flexible retaining clips 26a, 26b provide respective ramp surfaces that slide against the inner wall of the aperture in the component 16 and the panel 18 and cause the retaining clips 26a, 26b to be flexed inwardly as the fastening clip 12 is pressed into the aperture of the component 16 and the panel 18. Each flexible retaining clip 26a, 26b has a respective notch 29a and 29b (FIG. 3A) at an upper end thereof proximal to the flange 31. Once the clip body 19 passes substantially through the aperture of the panel 18 such that the ramp surfaces disengage the aperture's inner wall, the flexible retaining clips 26a, 6b automatically flex outwardly, causing the notches 29a and 29b to seat against the panel's 18 underside surface and, in cooperation with the flange 31 seated against the component's 16 topside surface, attach the clip body 19 to the component 16 and the panel 18. As best seen in FIG. 3A, the flexible retaining clips 26a and 26b are located diametrically opposite to one another on the clip body 19 with respect to the screw axis A.

Extending inwardly into the internal cavity of the fastening clip 12 are assorted pawl-like ratchet fingers 28, 30, 32 and 34 illustrated in FIG. 2B that are integrally formed with or otherwise positively attached to the inner periphery of clip body 19. These flexible ratchet fingers 28, 30, 32, 34 extend downwardly at an oblique angle into the internal cavity of the clip body 19 for ratcheting engagement with the threads of the threaded fastener 14. In the example illustrated in FIG. 2B, each ratchet finger 28, 30, 32, 34 includes at least one and, in some instances, two or three or more asymmetrical teeth. Asymmetrical teeth have a moderate slope on a leading edge and a much steeper slope on an opposing, trailing edge. As the threaded fastener 14 is moved longitudinally (downward in FIG. 2B) into the clip body 19 along screw axis A, the ratchet fingers 28, 30, 32, 34 are biased outward by the crests of passing threads and flex inwardly into the depression between neighboring threads. Each tooth is designed to seat between adjacent flanks of a neighboring pair of the threads, cupped against the thread pair's root; when seated, the steep trailing edge of the teeth prevent withdrawal of the threaded fastener 14 from the clip body 19.

The first and second ratchet fingers 32, 34 are located diametrically opposite to one another on opposing first and second sides of the internal cavity of the clip body 19. These two fingers 32, 34 are axially spaced or otherwise longitudinally offset to extend to first and second distinct axial positions, respectively, relative to the screw axis A. In the same vein, the third and fourth ratchet fingers 28, 30 are respectively located on the first and second sides of the internal cavity, and axially spaced to extend to third and fourth axial positions, respectively, relative to the screw axis A. The location and axial spacing of the ratchet fingers is engineered such that, at any given time, only one of the first and second ratchet fingers 32, 34 and only one of the third and fourth ratchet fingers 28, 30 seats within a root of an adjacent pair of the threads when the threaded fastener 14 is inserted into the internal cavity of the clip body 19. Synchronously, when these ratchet fingers 32, 30 are fully seated, the first and third ratchet fingers 34, 28 are unseated by the threaded fastener 14, deflected outwardly by respective flanks of the threads. Conversely, when the first and third ratchet fingers 34, 28 are fully seated between the flanks of neighboring threads, the second and fourth ratchet fingers 32, 30 are unseated by the threaded fastener 14. In instances where the threaded fastener 14 attempts to unintentionally translate upwardly in FIG. 2B (known as “spring back”), the unseated ratchet fingers will then fully seat to prevent unwanted backward motion.

A pair of flexible biasing tabs 27a and 27b are integrally formed with or otherwise positively attached to the outer periphery of clip body 19. Positioned adjacent to and circumferentially spaced from the flexible retaining clips 26a, 26b, the flexible biasing tabs 27a, 27b are located diametrically opposite one another on the clip body 19 with respect to the screw axis A. Each flexible biasing tab 27a, 27b extends circumferentially about the clip body 19, and flexes radially toward and away from the body 19. These biasing tabs 27a, 27b project outwardly from the clip body 19 to engage the inner wall of the aperture of the component 16 and the panel 18 upon insertion of the fastening clip 12 into the panel 18; the tabs flex against the inner wall and cooperatively bias the fastening clip 12 to a centered position within the aperture of the component 16 and the panel 18.

To attach the component 16 to the panel 18 utilizing the threaded fastener 14 and fastening clip 12, the body 19 of the fastening clip 12 is pressed or otherwise inserted, either manually or through an automated process, into the aperture until the portion 22a of the seal 22 seats against the top surface of the component 16 and the flexible retaining clips 26a, 26b pass through the aperture and seat the notches 29a, 29b against the underside surface of the panel 18. The flange 31 and flexible retaining clips 26a, 26b, once seated, cooperatively attach the fastening clip 12 to the component 16 and the panel 18. Moreover, the fastening clip 12 is configured to self center in the component 16 and the panel 18. For example, in various arrangements, the fastening clip is inserted into the panel 18 with the axis A through the fastening clip 12 being non parallel to an axis extending through the aperture in the panel 18. This ability to accept a larger degree of stud angles (that is, the angle between the axis A and the axis through the aperture in the component 16 and the panel 18) is enabled by permitting side-to-side movement of the fastening clip 12 while retaining the retaining clip's ability to “spring” back into position, whereas previous know configurations only allowed rotational alignment of the clip. Accordingly, the fastening clip 12 enables more interface designs between the fastening clip 12 and the panel 18 and a higher amount of clip applications.

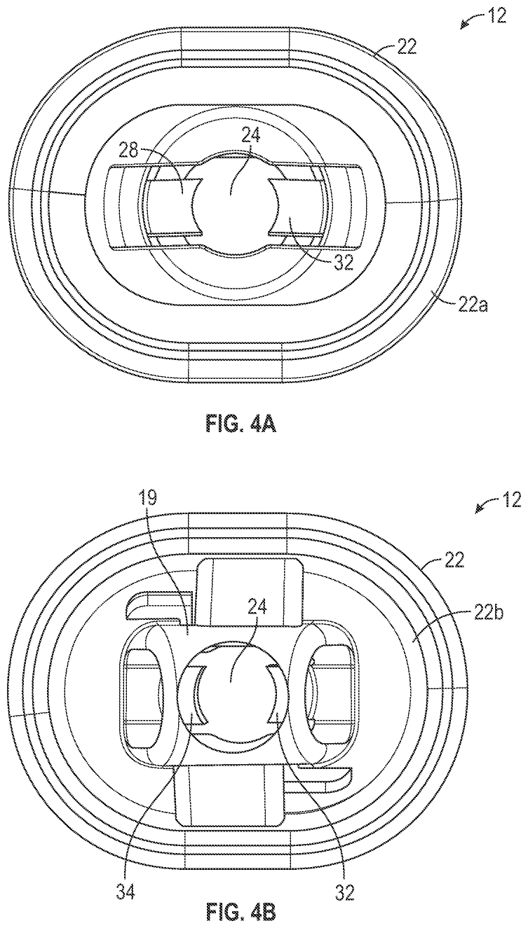

Prior to, contemporaneous with, or after mounting the fastening clip 12 to the component 16 and the panel 14, the shank of the threaded fastener 14 is passed through the complementary hole 24 (FIGS. 4A and 4B) of the fastening clip 12. Once the threaded fastener 14 and component 16 are mechanically coupled, the threaded fastener 14 then translated rectilinearly along the screw axis A into the internal cavity of the clip body 19. The assorted flexible ratchet fingers 28, 30, 32, 34 that extend into the internal cavity ratchet against the threads of the fastener 14, as described above. When the threaded shank 20 is fully inserted into the clip body 19, as seen in FIG. 1, at least one or, for at least some desired configurations, a subset of the pawl-like ratchet fingers 28, 30, 32, 34 seats within adjacent threads and locks the threaded fastener 14 to the fastening clip 12.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A fastening clip for attaching a component to a panel, the component and the panel having an aperture extending through the component and the panel, the fastening clip comprising:
a clip body that is inserted into the aperture, the clip body having an internal cavity that receives a threaded fastener along an axis of the cavity;
a plurality of retaining clips coupled to the clip body and projecting outwardly from the clip body, each of the retaining clips pressing against an undersurface of the panel to attach the retaining clip to the panel;
a plurality of biasing tabs coupled to the clip body and projecting outwardly from the clip body, the plurality of biasing tabs biasing the clip body to a centered position within the aperture when the clip body is inserted into the aperture, the plurality of retaining clips and the plurality of biasing tabs being configure to self-center the fastening clip relative to the component and the panel when the fastening clip is inserted non-perpendicular to the component and the panel; and
a seal member with an upper seal component and a lower seal component.

2. The fastening clip of claim 1 further comprising a plurality of ratchet fingers coupled to the clip body and extending inwardly into the internal cavity of the clip body, the plurality of ratchet fingers including at least two ratchet fingers being spaced apart and on opposite sides of the axis of the internal cavity.

3. The fastening clip of claim 2 wherein the plurality of ratchet fingers includes a third and fourth ratchet finger, the first, second, third and fourth ratchet fingers being axially spaced apart about the axis of the cavity.

4. The fastening clip of claim 1 wherein the biasing tabs are positioned diametrically opposite to each other with respect to the axis of the cavity.

5. The fastening clip of claim 1 wherein each of the plurality of fastening clips is integrally molded to the clip body.

6. The fastening clip of claim 1 wherein each of the plurality of biasing tabs is integrally molded to the clip body.

7. The fastening clip of claim 1 wherein the clip body, the plurality of retaining clips, and the plurality of biasing tabs are formed as a unitary structure.

8. The fastening clip of claim 1 wherein each of the retaining clips includes a ramp surface that engages with the aperture of the panel and component to cause the retaining clip to flex inwardly when the fastening clip is inserted the aperture of the component and panel.

9. An assembly of a panel and a component joined together by a fastening clip, the assembly comprising:
a clip body that is inserted into an aperture that extends through the panel and the component, the clip body having an internal cavity that receives a threaded fastener along an axis of the cavity;
a plurality of retaining clips coupled to the clip body and projecting outwardly from the clip body, each of the retaining clips pressing against an undersurface of the panel to attach the retaining clip to the panel;
a plurality of biasing tabs coupled to the clip body and projecting outwardly from the clip body, the plurality of biasing tabs biasing the clip body to a centered position within the aperture when the clip body is inserted into the aperture, the plurality of retaining clips and the plurality of biasing tabs being configure to self-center the fastening clip relative to the component and the panel when the fastening clip is inserted non-perpendicular to the component and the panel;
a plurality of ratchet fingers coupled to the clip body and extending inwardly into the internal cavity of the clip body, the plurality of ratchet fingers including at least two ratchet fingers being spaced apart and on opposite sides of the axis of the internal cavity; and
a seal member with an upper seal component and a lower seal component.

10. The assembly of claim 9 wherein the plurality of ratchet fingers includes a third and fourth ratchet finger, the first, second, third and fourth ratchet fingers being axially spaced apart about the axis of the cavity.

11. The assembly claim 9 wherein the biasing tabs are positioned diametrically opposite to each other with respect to the axis of the cavity.

12. The assembly of claim 9 wherein each of the plurality of fastening clips is integrally molded to the clip body.

13. The assembly of claim 9 wherein each of the plurality of biasing tabs is integrally molded to the clip body.

14. The assembly of claim 9 wherein the clip body, the plurality of retaining clips, and the plurality of biasing tabs are formed as a unitary structure.

15. The assembly of claim 9 wherein each of the retaining clips includes a ramp surface that engages with the aperture of the panel and component to cause the retaining clip to flex inwardly when the fastening clip is inserted the aperture of the component and panel.

16. A method of joining a panel and a component together with a fastener and a fastening clip, the method comprising:
inserting the fastening clip through an aperture that extends through the panel and the component, the fastening clip including:
a clip body that is inserted into the aperture, the clip body having an internal cavity that receives a threaded fastener along an axis of the cavity; a plurality of retaining clips coupled to the clip body and projecting outwardly from the clip body, each of the retaining clips pressing against an undersurface of the panel to attach the retaining clip to the panel; a plurality of biasing tabs coupled to the clip body and projecting outwardly from the clip body, the plurality of biasing tabs biasing the clip body to a centered position within the aperture when the clip body is inserted into the aperture, the plurality of retaining clips and the plurality of biasing tabs being configure to self-center the fastening clip relative to the component and the panel when the fastening clip is inserted non-perpendicular to the component and the panel; and a seal member with an upper seal component and a lower seal component; and
passing a fastener along the axis to join the panel and the component together.

17. The method of claim 16 wherein each of the plurality of fastening clips is integrally molded to the clip body.

18. The method of claim 16 wherein each of the plurality of biasing tabs is integrally molded to the clip body.

19. The method of claim 16 wherein the clip body, the plurality of retaining clips, and the plurality of biasing tabs are formed as a unitary structure.
